(19) United States
(12) Patent Application Publication
(10) Pub. No.: US 2005/0282116 A1
(43) Pub. Date: Dec. 22, 2005

(54) Root canal restoration dental material and a paste formulation for root canal restoration

(76) Inventor: Kazunori Kusano, Tokyo (JP)

Correspondence Address: GREENBLUM & BERNSTEIN, P.L.C., 1950 ROLAND CLARKE PLACE, RESTON, VA, 20191, US

(21) Appl. No.: 10/924,902

(22) Filed: Aug. 25, 2004

(30) Foreign Application Priority Data
Jun. 21, 2004 (JP) 2004-182538

(51) Int. Cl. A61C 5/02; A61C 5/00

(52) U.S. Cl. 433/224; 433/228.1

(57) ABSTRACT

The present invention provides a root canal restoration dental material and a paste formulation for root canal restoration which make it possible to examine a matching condition within a root canal through electronic measurement such as impedance measurement. The root canal restoration dental material of the present invention includes carbonnanotube. Further according to the present invention, a root canal restoration dental material includes a thermo-plastic polymer and an electric conductive material comprising carbonnanotube. The carbonnanotube is present in the material from approximately 0.5 to approximately 25 mass %. According to the present invention, a paste formulation for root canal restoration, in which a root canal restoration paste and an electric conductive material including carbonnanotube are present in the paste formulation, is provided.

### FIELD OF INVENTION

The present invention relates to a root canal restoration dental material and a paste formulation for root canal restoration, and more particularly, the present invention relates to the root canal restoration dental material and the paste formulation for dental use which makes it possible to examine a matching condition within a root canal through electronic measurement such as impedance measurement.

### BACKGROUND ART

In dental clinical treatments, a root canal treatment is often conducted. A root canal restoration treatment corresponds to a final operation of the root canal treatment and it is important to conduct the restoration operation precisely. That is, if the restoration were made beyond a root apex stricture, periodontal tissues around the root apex are irritated; and if the restoration was not completed to the root canal apex stricture, a residual dental pulp or a dead space around the root apex portion is allowed.

Materials which are often inserted to the root canal include points used for the root canal restoration such as a gutta-percha point or a silver point or a paste formulation for root canal restoration. Also a root canal restoration dental material, which has a formulation similar to the above points for the root canal restoration and is contained in an injector, is known. The composition may be filled in the root canal under heating upon the root canal restoration treatment so as to be discharged from the injector.

When the point for root canal restoration is inserted to the root canal, usually a working length is measured by an X-ray photograph of a reamer or a file inserted to the root canal and then, a main point having the same size with the final reamer or file which were used for enlargement of the root apex portion is selected. Thereafter, the length of the main point is sized to have the same length with the measured working length, and a tag back of the point is examined and further next, a matching condition is confirmed again by using an X-ray photograph; this confirmation is referred as a trial matching. Thereafter, the restoration operation is performed by the filling the main point followed by restoration accessory points. In this operation, a sealer or a chloro-percha may be filled, or the points may be softened and pressured so as to make contacts thereof to root canal walls and a root canal apex direction for providing close packing of the root canal as soon as possible. When the root canal restoration has been completed, again another X-ray photograph is taken so as to examine whether or not the matching condition is acceptable.

However, in the above described operation, since the examinations of the matching conditions are made by the X-ray photograph, the following problems are presented. That is, since the procedure using the X-ray photograph is based on the observation of two-dimensional images of the three-dimensional root canal, near and far relations are determined but the 3-dimensional relations in positions must be mere inferred and have less precision. In addition, for the cases of gravida, the X-ray exposure itself is not adequate. Furthermore, the method using the X-ray photograph has other defects such that time consumption and elaboration are large when compared to the method using electric measurement such as impedance measurement.

To improve or solve the above difficulties, the techniques in which the matching condition of the gutta-percha points is examined by the impedance measurement (patent literature 1, patent literature 2) have been proposed so far. The patent literature 1 discloses a gutta-percha point with a surface coated by an electric conductive material and a gutta-percha point containing electric conductive powder. However, it is expected to further improve properties such as heat conductivity, elasticity, strength, and stabilities to tissue fluid and medical solutions in the gutta-percha point disclosed in the patent literature 1. Further recently, it is expected to use thermal plastic polymers other than gutta-percha because of exhaust of the natural material such as gutta-percha.

In the patent literature 2, a gutta-percha point is proposed in which a metal wire is inserted to the gutta-percha point. However, the technique disclosed in the patent literature 2 has several advantages as pointed out below:
(1) the metal wire must be cut or be removed after the root canal restoration operation;
(2) when the metal wire is removed, packing property of the gutta-percha point is degraded;
(3) integrity of the metal wire and the gutta-percha point is lost and only the metal wire reaches to the root apex stricture so that the dead space may created in the root canal; and
(4) integrity of the metal wire and the gutta-percha point is lost and the metal wire extends outside the root apex stricture so that inflammatory may be caused to the root apex periodontal tissues.

In addition, the silver point has advantages in which the impedance measurement is used and the silver point has sufficient elasticity; however, erosion by tissue fluid tends to occur because of its poor matching property to root canal walls and removal of the silver point is difficult.

Furthermore, when a root canal restoration dental material retained in an injector is filled in the root canal or when a paste formulation for the root canal restoration is filled in the root canal, an injection method is often applied by using a cylinder or an injector etc.

The technology which uses an injector is known and a paste formulation for root canal restoration prepared by adding electric conductive materials to a conventional paste for root canal restoration is used (patent literature 3). In the paste formulation for root canal restoration disclosed in the patent literature 3 makes it possible to examine the root canal length and the matching condition of the paste in the root canal at the same time. However, even in the paste formulation disclosed in the patent literature 3, it is further required to improve its stability of the electric conductive materials to tissue fluid and medical solutions so as to obtain further improved material properties while further improving elasticity after the restoration operation, durability, thermal conductivity and stabilities to tissue fluid and medical solutions.

<List of Prior Art Literatures>

Patent Literature 1: Japanese Patent No. 3490378
Patent Literature 2: Japanese Patent (Laid-Open) Heisei No. 9-140728
Patent Literature 3: Japanese Patent No. 3501290

### SUMMARY OF INVENTION

### Work and Advantage

According to the root canal restoration dental material and a paste formulation for root canal restoration in the present invention, electric conductivity is provided by electric conductive materials including carbonnanotube so that the root canal restoration composition or the paste formulation for root canal restoration is used as current proves electric measurement and also so that the matching condition in the root canal may be examined by using the impedance measurement thereby making it possible to examine the matching condition in the root canal easily, quickly, and precisely; in turn thereby making it possible to ensure easy, precise, and quick the root canal restoration operation.

In addition, according to the root canal restoration dental material, the electric conductivity is essentially provided by carbonnanotube, and the root canal restoration composition has excellent thermal conductivity, elasticity, strength and stabilities to medical solutions.

Moreover, the paste formulation for root canal restoration of the present invention also includes electric conductive materials comprising carbonnanotube having excellent electric conductivity together with excellent elasticity, strength and stabilities to tissue fluid or medical solutions such that the paste formulation exhibits a stable material property.

Furthermore, the elasticity, strength, thermal conductivity and stabilities against the tissue fluid or drag agents are still kept at excellent levels.

### Objects to be Solved by Invention

An object of the present invention is to provide a root canal restoration dental material which makes it possible to overcome the above problems and to examine the matching condition in the root canal easily, quickly, and precisely by the electric measurement such as impedance measurement; the root canal restoration dental material has excellent thermal conductivity, elasticity, strength, and stabilities to tissue fluid and drag agents.

In addition, an object of the present invention is to provide a paste formulation for root canal restoration which makes it possible to overcome the above problems and to examine the matching condition in the root canal easily, quickly, and precisely by the electric measurement such as impedance measurement; the paste formulation for root canal restoration has excellent thermal conductivity, elasticity, strength, and stabilities to tissue fluid and medical solutions.

### Means for Solving Problems

In order to solve the above problems, the root canal restoration dental material of the present invention is characterized in that the material includes carbonnanotube.

The root canal restoration dental material of the present invention is characterized in that the composition includes a thermo-plastic polymer and the carbonnanotube.

In the present composition, carbonnanotube may be present from approximately 0.5 to approximately 25 mass %.

In the present composition, a surface of the body including the thermo-plastic polymer may be coated by electric conductive materials comprising carbonnanotube.

Any of the above thermo-plastic polymer may be selected from the group consisted of gutta-percha, polyethylene, polypropylene, polyethylene-glycol, polypropylene-glycol, and any admixture thereof.

Any of the above composition may further include an X-ray imaging agent.

In any of the above composition, the thermo-plastic polymer may include at least one compound selected from the group consisted of zinc oxide, calcium hydroxide, hydroxyl apatite, tricalcium phosphate, potassium sulfate, iodoform, barium sulfate, zinc sulfate anhydrate, bismuth bicarbonate, and any admixture thereof.

Furthermore, the above composition may be formed as a point for root canal restoration.

Moreover, in order to solve the above problem, the present paste formulation for root canal restoration is characterized in that the paste formulation includes components for root canal restoration and carbonnanotube.

In the above paste formulation for root canal restoration may include carbonnanotube from approximately 0.5 to approximately 25 mass %.

Any of the above paste formulation for root canal restoration may further include an X-ray imaging agent.

In any of the above paste formulation for root canal restoration, the thermo-plastic polymer may include at least one compound selected from the group consisted of zinc oxide, calcium hydroxide, hydroxyl apatite, tricalcium phosphate, potassium sulfate, iodoform, Barium sulfate, zinc sulfate anhydrate, bismuth bicarbonate, and any admixture thereof.

### BRIEF EXPLANATION OF DRAWINGS

FIG. 1 shows a side view of the root canal restoration dental material for dental use as a first embodiment.

FIG. 2 shows a cross sectional view of the root canal restoration dental material for dental use shown in FIG. 1 along with a line A-A.

FIG. 3 shows the cross sectional view of the second embodiment of the root canal restoration dental material.

FIG. 4 shows the root canal restoration dental material of the third embodiment.

FIG. 5 shows a current measuring device used in examples.

FIG. 6 shows a plot of the volume resistivity of the paste formulation obtained by the present invention which was plotted against the total amount of carbonnanotube (mass %) to the total mass of the paste formulation.

### EXPLANATION OF NUMERALS

1,11—root canal restoration dental material
2—non-conductive part
3—coarting
4—end portion
5—filler
6—electric conductive powder
12—container part
13—pressure part
14—injection part
21—root canal
100—resistance measuring device
101—current detector
102—power supply
103—control circuit
104—electrode
105—current indicator
106—electrode
P—root canal stricture
T—patient tooth

### BEST MODE FOR PRACTICING INVENTION

Hereunder, the present invention will be explained in detail.

### First Embodiment

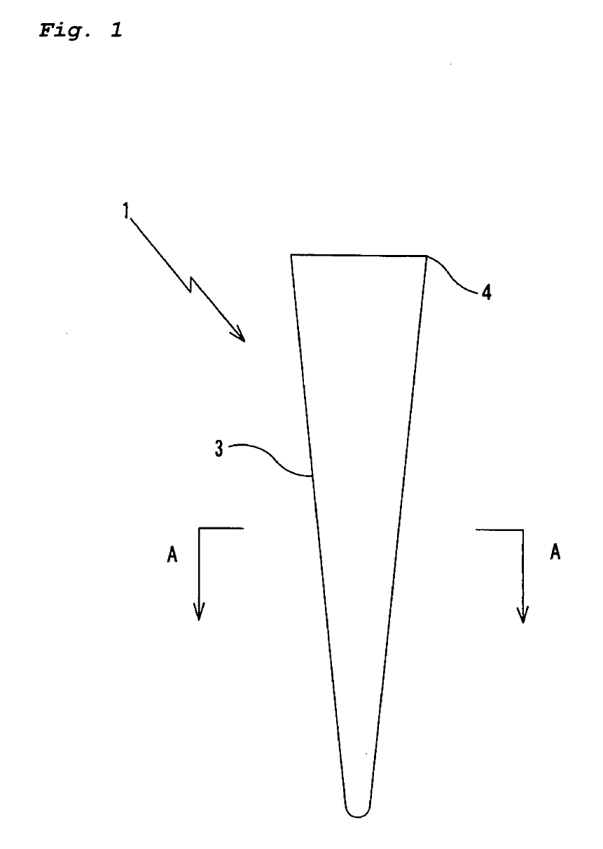

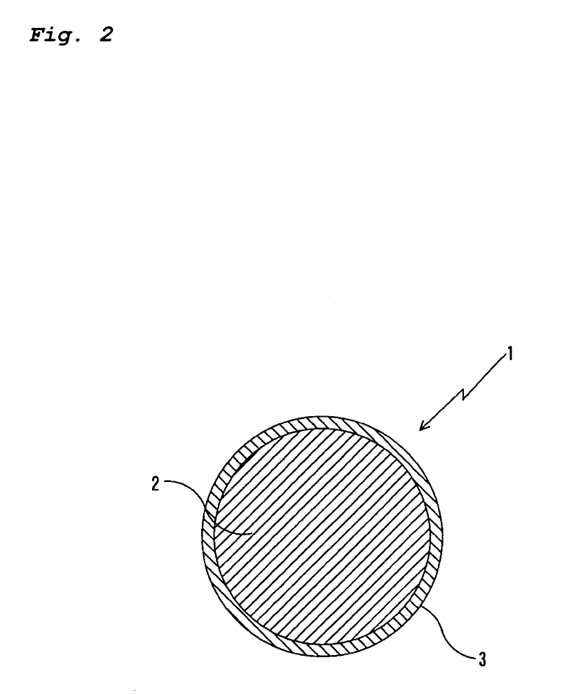

FIG. 1 generally shows a side view of the root canal restoration dental material 1 as a first embodiment. FIG. 2 shows a cross sectional view of the root canal restoration dental material 1 for dental use shown in FIG. 1 along with the line A-A.

The root canal restoration dental material 1 is formed to have a shape similar to conventional root canal restoration points, and as shown in FIG. 2, the non-conductive part 2, which corresponds the “body” in claimed invention), comprises a compound formed to the shape of the root canal restoration point. The surface of the non-conductive part 2 is coated by the coating 3 of uniform thickness formed with electric conductive materials comprising carbonnanotube. The non-conductive part 2 comprises the compound comprising thermo-plastic polymer, wax and fillers.

The thermo-plastic polymer used for the present root canal restoration composition 1 may be selected from the polymers having bio-acceptability and having softening points between 45 Celsius degrees to 80 Celsius degrees. Such polymers may include such as, for example, gutta-percha, polyethylene, polypropylene, polyethylene glycol, polypropylene glycol, and any admixture thereof. Gutta-percha used in the present root canal restoration composition for dental use is defined as the purified and dried ingredient obtained mainly from Sapotaceae Payena.

Amounts of use of the thermal-plastic polymer may range from 10 to 25 mass % to the mass of the root canal restoration dental material so as to provide adequate mold properties.

The wax in the root canal restoration dental compound according to the present invention is used to provide adequate flexibility to the thermo-plastic polymers while providing adequate lubrication property thereto. The wax described above may include a paraffin wax, Japan tallow, a bees wax, and any admixture thereof. The wax may not be included in the material; however, if the wax is present in the material, the wax may present from 5 to 20 mass % to the total mass of the root canal restoration dental material 1 so that adequate flexibility and lubrication property may be provided thereto.

Fillers present in the root canal restoration dental material 1 of the present invention may be selected from any filler known in the art that has been allowed to the root canal restoration dental material 1, and more particularly, include zinc oxide, calcium hydroxide, hydroxyl apatite, tricalcium phosphate, titan oxide, bismuth bicarbonate, barium sulfide, aluminum sulfide, iodoform, zinc sulfide anhydrate. More especially, hydroxyl apatite and tricalcium phosphate are preferred since the adequate bio-accessibility is obtained and less irritation to intra-oral tissues is predicted. In addition, the filler such as bismuth bicarbonate and/or barium sulfate may be used together in order to provide an acceptable X-ray imaging property. The above filler may be present in the rot canal restoration composition for dental use 1 from 1 to 70 mass %.

The electric conductive material used in the present root canal restoration dental material 1 may only be carbonnanotube and may be an admixture of the carbonnanotube and other electric conductive materials.

Such carbonnanotube may be selected any type of carbonnanotube as far as it has excellent conductivity, and such grades of carbonnanotube are commercially available, for example, from Microphase Co. (Japan Tsukuba-shi).

According to the present invention, electric conductive materials other than the carbonnanotube may be used from the group consisted of Au (gold), Pt (platinum), Cu (cupper), Ti (titanium), Ni (nickel), Pd (palladium), carbon black, and any admixture thereof.

A method for producing the present root canal restoration dental material may comprise the steps of: preparing the compound of the thermo-plastic polymer, the filler and the wax depending on requirements for particular applications, subsequently molding the compound into a point shape for root canal restoration dental material, and then applying a coating on the surface of the point by the electric conductive material including the carbonnanotube.

For applying the coatings of the electric conductive material including the carbonnanotube on the compound shaped as the root canal restoration point, a dry process such as vacuum evaporation or sputtering and wet processes in which the point is immersed into a dispersed solution including fine particles of the electric conductive material including carbonnanotube, a solvent or solvents, and a binder or binders.

When the coating is formed by the dry process, the compound shaped to the root canal restoration point is placed in a vacuum vessel, and then the electric conductive material including carbonnanotube is deposited onto the surface of the points.

Alternatively, when the wet process is used, any apparatus, any binder, and any dispersion solvent may be used in order to produce the coatings. The binders may be selected from thermal cure type resins and thermo-plastic resins, such as for example, an epoxy resin, a urethane resin, a phenol resin, a silicone resin, and an acryl resin and the like. In the above binder or binders, the electric conductive material including carbonnanotube may be dispersed, and thereafter, the coating may be applied on to the surface of the point shaped compound. Amounts of the electric conductive materials to the binder may be selected so as to provide adequate volume conductivity which allows a method by the electric measurement is applied. For example, when only the carbonnanotube as the electric conductive material is dispersed in the binder, the carbonnanotube may be included in the compound from approximately 0.5 to approximately 25 mass %. When the dip coating is conducted on the point, small amounts of the solvent which can dissolve thermo-plastic polymers such as chloroform may be used together with other solvents.

In addition, the coating may be formed to have sufficient thicknesses to provide strength and sufficient electric conductivity to the point, and such thickness of the coating may adequately adjusted in the range from several tens nano-meters to several tens micrometers.

The above described root canal restoration dental material 1 has the similar shape with conventional root canal restoration point and includes similar major components which are contained in the conventional root canal restoration points. Therefore, the root canal restoration composition 1 may be used as the conventional root canal restoration points with respect to the operability of the root canal restoration.

The surface of non-conductive part 2 of the root canal restoration dental material 1 is coated by the coating 3 of the electric conductive material including the carbonnanotube so that it has high conductivity as whole. When one electrode of an electric root canal length detection apparatus (not shown) is connected to the end 4 of the root canal restoration dental material 1 shown in FIG. 1 and the other electrode of the electric root canal length detection apparatus is connected to a lip, the matching condition in the root canal can be examined by the electronic measurement such as an impedance method and it is made possible to examine the matching condition in the root canal easily, quickly, and precisely thereby making the root canal restoration easily, quickly, and precisely.

Moreover, in the root canal restoration dental material 1, the electric conductivity is provided by the electric conductive material including the carbonnanotube. The carbonnanotube has high thermal conductivity, excellent elasticity and strength while having low reactivity so that it exhibits excellent stability to tissue fluid and medical solutions. Carbonnanotube categorized to have good conductivity even exhibits the electric conductivity over metal. Thus, the root canal restoration dental material may exhibit high thermal conductivity and may provide good thermal and electric feeling to patients such that the root canal restoration dental material 1 is preferably used to the root canal restoration due to the material properties such as elasticity, strength, stability to tissue fluid and medical solutions.

Here, the coating 3 shown in FIG. 2 is applied to the entire circumference of the root canal restoration dental material 1, however, the coating 3 formed by the dry process may not be applied to the entire circumference of the root canal restoration dental material 1 and the coating 3 may be formed as a strip or strips extending between both ends.

### Second Embodiment

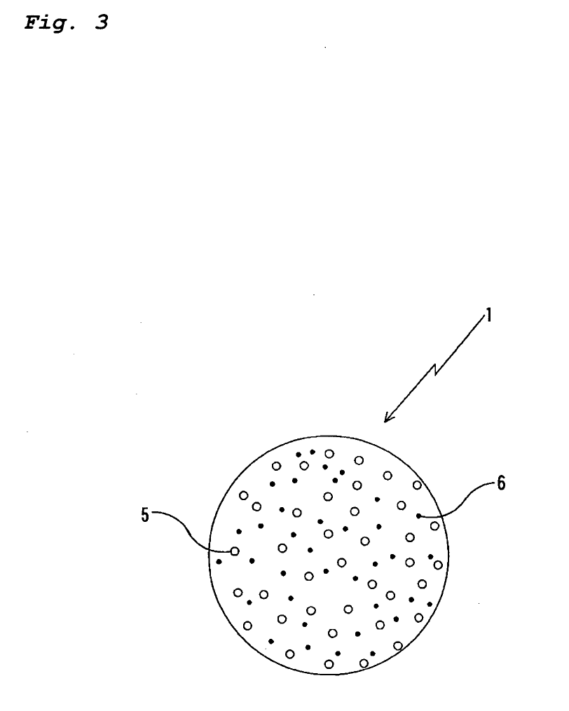

FIG. 3 shows the cross sectional view of the second embodiment of the root canal restoration dental material 1. The root canal restoration dental material 1 is obtained by adding the electric conductive material including carbonnanotube and dispersing the electric conductive material in components for the root canal restoration point. Here, the electric conductive materials including carbonnanotube may include those explained in the first embodiment and such electric conductive materials may be preferred to be powder or particles when considering addition and dispersion of the root canal restoration points.

As shown in FIG. 3, the root canal restoration dental material is shaped to the conventional root canal restoration point; and as shown in FIG. 3, the root canal restoration dental material 1 includes the electric conductive powder 6 which is mixed and dispersed together with the fillers 5.

A method for producing the root canal restoration dental material 1 may be selected from several known methods such as a wet molding in which thermo-plastic polymers, fillers, and electric conductive materials including carbonnanotube are mixed and dispersed under a wet condition, and thereafter solvents are removed from the composition and an extrusion molding with an extruder or an injection molding after mixing and dispersing under a dry condition with a mixing machine.

Depending on particular applications, the root canal restoration point may be formed by the outer compound which contains the electric conductive powder 6 and the inner compound which does not have electric conductivity in order to provide the electric conductivity particularly to the outer circumference of the point. The outer compounds containing the electric conductive powder 6 may be formed to cover the circumference of the point or may be formed as strips extending to the longitudinal direction of the point. Alternatively, it may be possible to provide the electric conductivity to the inside by compounding the electric conductive materials 6 and the non-electric conductive compound. Molding methods used to produce the above points may include a multi-stage extrusion method in which the electric conductive compound and the non-electric conductive compound are extruded at the same time and an injection molding method.

Total amounts of the electric conductive material 6 in the second embodiment may range from approximately 0.5 to approximately 25 mass % to the total mass of the root canal restoration dental material when the electric conductive material 6 is only consisted of carbonnanotube.

In such root canal restoration dental material 1, as similar to that of the first embodiment, the shape is the conventional root canal restoration point and has similar major components. Therefore, the present root canal dental restoration 1 still maintains conventional operability of the root canal restoration as the conventional root canal restoration points.

The root canal restoration dental material 1 is coated by the coating 3 of the electric conductive material including the carbonnanotube so that it has high conductivity. As described in the root canal restoration dental material 1 of the first example 1, when one electrode of an electric root canal length detection apparatus (not shown) is connected to the end 4 of the root canal restoration dental material and the other electrode of the electric root canal length detection apparatus is connected to a lip, the matching condition in the root canal can be examined by the electronic measurement such as an impedance method and it is made possible to examine the matching condition in the root canal easily, quickly, and precisely thereby making the root canal restoration easily, quickly, and precisely.

Moreover, in the root canal restoration dental material 1 of the second embodiment, since the electric conductivity is provided by the electric conductive material including the carbonnanotube so that the root canal restoration dental material 1 is preferably used to the root canal restoration due to the material properties such as elasticity, strength, stability to tissue fluid and drag agents.

### Third Embodiment

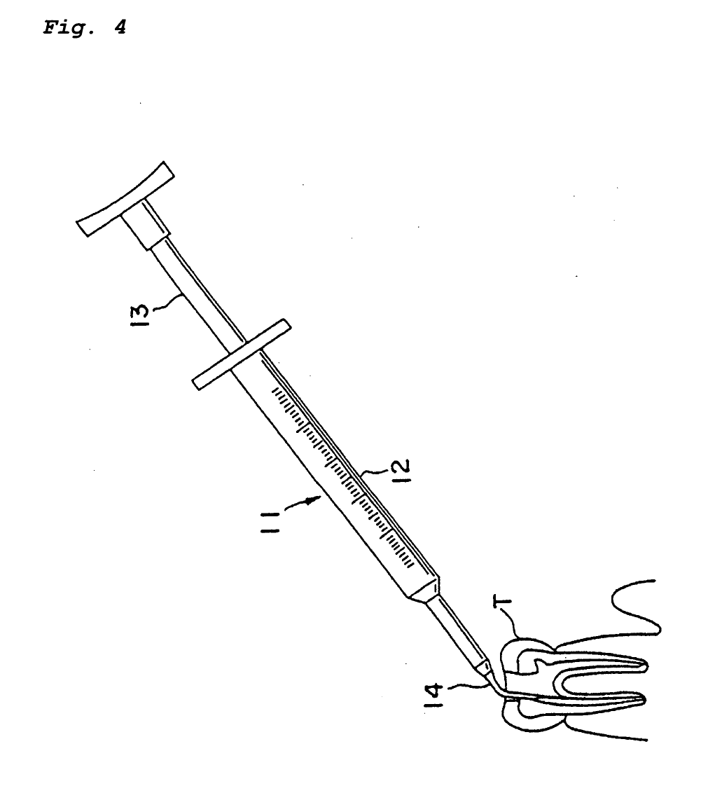

FIG. 4 generally shows the root canal restoration dental material of the third embodiment. The root canal restoration dental material 11 shown in FIG. 4 has the same ingredients with those explained in the second embodiment. The material comprises the dispersion of thermo-plastic polymer, wax, fillers and carbonnanotube. Then, the material is filled into the container part 12 of the injector. The root canal restoration dental material 11 becomes fluidity enough to be discharged from the injection part 14 upon heating when the material is injected. As shown in FIG. 4, the material 11 can be injected into the root canal by injecting the top portion of the injection part 14 into the root canal of a patient tooth T, and under this position, inserting the pressure part 13 into the container part 12.

The electric conductive materials used in the root canal restoration dental material of the third embodiment may be used those described in the present first embodiment. Such electric conductive materials are preferred to have powder shapes as described in the second embodiment. In addition, when carbon powder is added to the composition as the electric conductive material, the effect of absorption of formaldehyde which is major ingredient of form-cresol used to treat the root canal.

The powder is preferred to have the size from 1 nm to 100 micrometers, and is more preferred to have the size from 10 micrometers to 80 micrometers, and the most preferably to have the size from 10 micrometers to 50 micrometers. With respect to the particle shape, powder in spherical, pin, scale shapes may be used. Particularly, the pin shaped powder makes it possible to improve volume resistivity of the root canal restoration dental material at relatively lower amounts.

The volume resistivity of the root canal restoration dental material 11 according to the third embodiment may range from 10⁻² Ωcm to 10⁶ Ωcm it is preferred that the resistivity of the root canal restoration dental material becomes almost same resistivity through periodontal membrane. If the volume resistivity becomes too high, detection of the restoration to the root canal stricture by the impedance measurement could not provide sufficient accuracy.

The root canal restoration dental material 1 of the third embodiment includes the electric conductive material including carbonnanotube and hence, the composition has sufficient electric conductivity. Therefore, the root canal restoration composition filled in the root canal may be used as an electric probe thereby allowing examination of the matching condition in the root canal by a conventional electric measurement such as the impedance method easily, quickly and precisely.

Also as the foregoing embodiment, the root canal restoration composition 1 of the second embodiment, since the electric conductivity is provided by the electric conductive material including the carbonnanotube so that the root canal restoration dental material 1 is preferably used to the root canal restoration due to the material properties such as elasticity, strength, stability to tissue fluid and medical solutions.

### Fourth Embodiment

The fourth embodiment of the present root canal restoration composition is prepared as the paste formulation for root canal restoration and includes conventional components for root canal restoration paste and an electric conductive material including carbonnanotube. Such paste formulation is prepared by mixing the electric conductive material including carbonnanotube to the components for forming the conventional paste formulation such as a calcium hydroxide paste, a zinc oxide-eugenol paste formulation, an iodoform paste formulation, a paraform-formalin paste formulation.

These conventional paste compositions may include, particularly commercially available basis, for example Triozinc pasta which is a mixture of paraform aldehyde, anhydrous zinc sulfate, aluminum sulfate, potassium sulfate, zinc oxide mixed with cresol, phenol, and creosote; Kri 1 which is a mixture of iodoform powder, para-chrolophenol camphor, menthol, lanolin, glycerin; Carbitar which is a mixture of iodoform powder, calcium hydroxide powder, sulfathiazole powder, guanofuracin with a vehicle such as T-caine and guanofuracin; Bitapex which is a mixture of calcium hydroxide powder and iodoform powder with silicone: oil; FR which is a mixture of calcium hydroxide powder, zinc oxide powder, barium sulfate powder, and a vehicle such as guaiacol-formaldehyde mixture, propylene glycol, dry ethanol, caster oil, liquid paraffin; Sealapex which comprises a polymer resin and calcium hydroxide.

Other paste formulations such as Endofil which uses a polymeric material as a base and the paste formulations which use hydroxyl apatite or tricalcium phosphate may be useful, because such paste formulations exhibit affinity to live tissues and accelerate hard tissues formation. These paste formulations may provide advantages that the formulation may be absorbed by the tissues if the paste formulation runs out from the apical stricture.

The electric conductive materials used in the paste formulation of the present invention may be used those described in the present third embodiment.

The volume resistivity of the paste formulation according to the fourth embodiment may range from 10⁻² Ωcm to 10⁶ Ωcm. It is preferred that the resistivity of the paste formulation becomes almost same resistivity through periodontal membrane. If the volume resistivity becomes too high, detection of the restoration to the root canal stricture by the impedance measurement could not provide sufficient accuracy.

Total amounts of the electric conductive material including carbonnanotube may be selected so as to provide sufficient volume resistivity to the paste formulation and the carbonnanotube may be preferably included from approximately 0.5 mass % to approximately 25 mass % in the paste formulation and may be included more preferably from approximately 1 mass % to approximately 25 mass % in the paste formulation.

Total amount of vehicles included in the paste formulation may range from 10 mass % to 70 mass % in the paste formulation and may range more preferably from 30 mass % to 60 mass %.

Here, a sample paste formulation, which includes a paste containing calcium hydroxide as its major ingredient and the electric conductive materials including carbonnanotube, will be explained hereunder.

First, calcium hydroxide is prepared. This calcium hydroxide may be used under the specification of Japanese Pharmacopoeia having the particle size from 10 to 50 micrometers. In this paste formulation, iodoform may preferably be present, because an anti-bacterial activity may be extremely enhanced and an X-ray imaging performance may be also improved. In addition, the vehicle described above such as silicone oil etc. may be added to calcium hydroxide. Addition of the silicone oil may provide an anti-corrosion property to the paste formulation as well as providing an adequate flow performance. Other additives to the calcium hydroxide may be selected from various types. For example, when X-ray contrast agents including bismuth bicarbonate, bismuth sulfate, zirconium silicate may improve the X-ray imaging performance of the paste.

A dispersion method for the powder may be selected from any well-known conventional dispersion methods. Especially, when the electric conductive powder having the particle size between 10 and 50 micrometers is used as described above, it is possible to apply various mixing and/or dispersion methods, because aggregation of the powder may not be so severe. In the preparation of the electric conductive paste formulation according to the present invention, the paste formulation may be prepared, for example, by providing a paste formulation which is premixed with calcium hydroxide, iodoform, and silicone oil, adding the electric conductive powder, mixing the resulted paste formulation again to formulate the paste formulation, then filling the resulted electric conductive paste formulation into the injector in a form of a cylinder for use when necessary.

However, it is possible to mix a non-conductive powder such as calcium hydroxide and the electric conductive powder together with the vehicle such as silicone oil at the same time so far as the paste formulation according to the present invention may be obtained.

As described above, the paste formulation of the present invention includes the electric conductive material including carbonnanotube so that the paste formulation may have electric conductivity. Therefore, the matching condition in the root canal can be examined by the electric measurement using the conventional impedance measurement in which the paste filled in the root canal is used as a current probe and then the root canal length and the matching condition in the root canal are easily, quickly and precisely detected.

Moreover, the paste formulation of the present invention includes the electric conductive material including carbonnanotube so that the paste formulation exhibits stable properties such as elasticity, strength, thermal conductivity, stability to tissue fluid and medical solutions.

Furthermore, in the paste formulation of the present invention, major ingredients are almost similar to those of the conventional paste for root canal restoration and then, the conventional operability is ensured in that conventional injection methods such as the method using the injector in a form of a cylinder with the same operability as the conventional root canal restoration by the paste.

Furthermore, according to the present root canal restoration dental material and the paste formulation, the X-ray photograph may not be used to examine the matching condition in the root canal, because the electric measurement such as impedance measurement is available; however when combined with the X-ray photograph, the matching condition of the root canal can be more certainly such that the root canal restoration will be completed more precisely.

Here, when the X-ray photograph is omitted from the examination of the matching condition, numbers for taking X-ray photograph are reduced or omitted such that exposure of X-ray to patients may be significantly reduced.

Now, the present invention will be explained by practical examples; however the present invention is not limited to the particular examples described hereunder.

### EXAMPLES

### Example 1

<Root Canal Restoration Point Coated with Carbonnanotube>

For 75 Celsius degrees usage, 20 mass % of gutta-percha as a thermo-plastic polymer, 7 mass % of paraffin wax and 5.5 mass % of wood wax as the wax component, 66 mass % of hydroxyl apatite as the filler, and 1.5 mass % of bismuth bicarbonate were heated and mixed under a predetermined viscosity to form the root canal restoration point. Then the root canal restoration point obtained was placed in a sputtering apparatus and carbonnanotube in the grade (A+B) type listed in Table 1 commercially available from Microphase Co. (Japan Tsukuba-shi) was coated on the point and the coated gutta-percha point was obtained.

### Example 2

<Root Canal Restoration Point Coated with Carbonnanotube>

The root canal restoration point prepared in Example 1 was placed in the sputter apparatus and then carbonnanotube of the grade (C+D) type listed in Table 1 was coated to the root canal restoration points to prepare a coated gutta-percha point.

Using the coated root canal restoration points obtained in Example 1 and Example 2 were inserted to an enlarged root canal while detecting the root canal length using an electric root canal restoration apparatus and the apparatus succeeded in detecting the arrival of the point to an apical sheet as the root canal restoration operation by a conventional silver point and a good operation of root canal restoration was conducted.

### Example 3

<Root Canal Restoration Point Including Carbonnanotube>

For 75 Celsius degrees usage, 20 mass % of gutta-percha as a thermo-plastic polymer, 7 mass % of paraffin wax and 5.5 mass % of a Japan tallow as the wax component, 63 mass % of hydroxyl apatite as the filler, 1.5 mass % of bismuth bicarbonate and 3 mass % of carbonnanotube in the grade (A+B) type listed in Table 1 commercially available from Microphase Co. (Japan Tsukuba-shi) were heated and mixed under a predetermined viscosity to form the root canal restoration point.

### Example 4

<Root Canal Restoration Point Including Carbonnanotube>

The root canal restoration point was prepared as the same procedure described in Example 3 but carbonnanotube of the grade (C+D) type listed in Table 1 was used.

Using the root canal restoration points obtained in Example 3 and Example 4 were inserted to an enlarged root canal while detecting the root canal length using an electric root canal restoration apparatus and the apparatus succeeded in detecting the arrival of the point to an apical sheet as the root canal restoration operation by a conventional silver point and a good operation of root canal restoration was conducted.

As described Examples 1-4, both grades (A+B) and (C+D) types of carbonnanotube commercially available from Microphase Co. were preferably used in the electric conductive material.

### Example 5

<Preserved Root Canal Restoration Composition in Injector>

The same compound of Example 3 was subjected to heat-mixing and the filled in the injector as shown in FIG. 4.

### Example 6

<Preserved Root Canal Restoration Composition in Injector>

The same compound of Example 5 wad subjected to heat-mixing but carbonnanotube of the grade (C+D) type listed in Table 1 was used and the filled in the injector as shown in FIG. 4.

The root canal restoration materials prepared in Examples 5 and 6 preserved in the injector shown in FIG. 4 were heated and it was confirmed that the root canal restoration composition was discharged through the top of the injector. Then the top part of the injection 14 was inserted to the root canal of the damaged tooth T and subsequently the pressure part 13 was inserted into the container part 12 so as to inject the composition to the root canal by discharging the root canal restoration composition through the injection part 14.

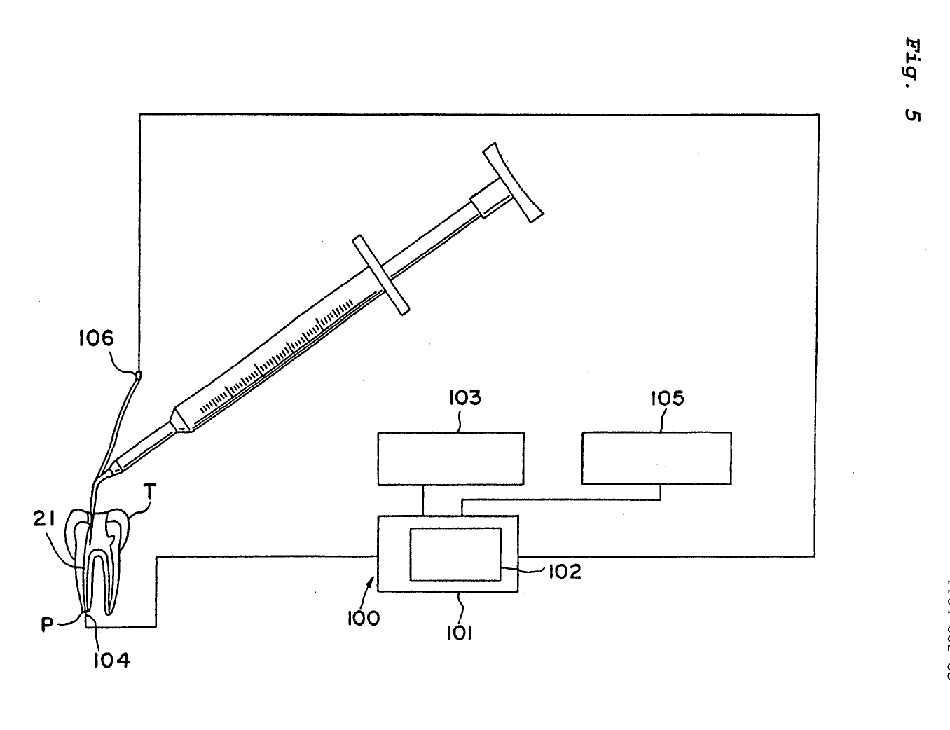

The filling of the root canal restoration dental material was detected by using the resistance measuring device shown in FIG. 5. The resistance measuring device 100 shown in FIG. 5 comprises the current detector 101, the power supply 102, the control device 103 including relay circuit, the electrode 104 connected to the damaged tooth through lip, the current display device 105 including a current indication device and/or an alarm device, and the electrode 106 connected to an end of a reamer. The resistance measuring device 100 actuates the current display device 105 through the control device 103 based on the current signal detected by the current detector 101. The resistance measuring device 100 acknowledges to the operator that the resistances or the current values become a predetermined value, or the top of the reamer reaches to the apical stricture P, or the top of the reamer reaches to the position having a predetermined distance, i.e., about 1 mm from the apical stricture P.

The top of the electrode 104 of the resistance measuring device 100 shown in FIG. 5 was placed at the position slightly inside of the apical stricture P and the root canal restoration dental material was injected to the root canal. The root canal restoration dental material reached to the apical stricture and then circuit completion through the root canal restoration dental material was electrically detected. Then, the root canal restoration operation was possible while detecting completion of the filling of the root canal restoration dental material to the apical stricture.

### Example 7

<A Paste Formulation Including Carbonnanotube>

To the solid component including 50 mass % of calcium hydroxide (Wako Junyaku Kogyo, Japan) as the filler, 20 mass % of iodoform as the X-ray imaging agent, 30 mass % of silicone oil as the vehicle was mixed to prepare a paste formulation, and to this paste formulation, 1.8 mass % of the carbonnanotube to the total weight of the paste formulation of the grade (A+B) type from Microphase Co. (Japan, Tsukuba-shi) was added and mixed to form the paste formulation of the present invention.

### Example 8

<A Paste Formulation Including Carbonnanotube>

Using the similar paste formulation except the amounts of carbonnanotube, the paste formulation of the present invention including 25 mass % of carbonnanotube grade (A+B) type to the total mass of the paste formulation was prepared by mixing the above admixture.

### Example 9

A Paste Formulation Including Carbonnanotube>

To the solid component including 40 mass % of calcium hydroxide (Wako Junyaku Kogyo, Japan) as the filler, 10 mass % of iodoform as the X-ray imaging agent, 50 mass % of silicone oil as the vehicle was mixed to prepare a paste formulation, and to this paste formulation. 25 mass % of the carbonnanotube to the total weight of the paste formulation of the grade (A+B) type from Microphase Co. (Japan, Tsukuba-shi) was added and mixed to form the paste formulation of the present invention.

Volume resistivity of each paste formulation according to the present invention was measured. The results are listed in Table 2 shown hereunder. As shown in Table 2, the paste of Example 7 has its volume resistivity to be 200 kΩcm; the paste of Example 8 has its volume resistivity to be 200 Ωcm; and the paste of Example 9 has its volume resistivity below a detection limit of a detector and then estimated to be about 200 Ωcm. Therefore, the paste formulations prepared in Examples 0.7-9 were confirmed to have sufficient electric conductivity.

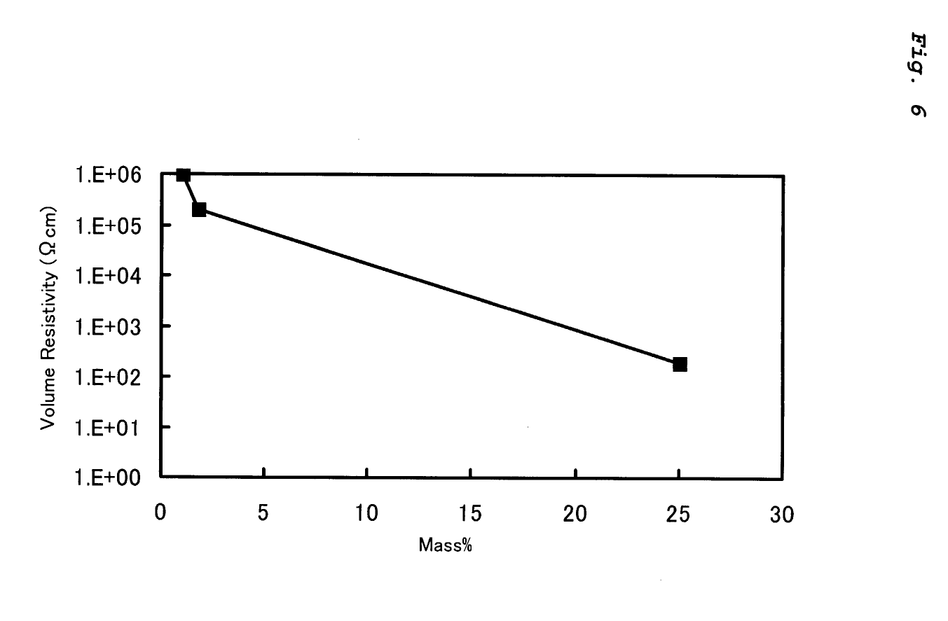

In FIG. 6, the volume resistivity of the paste formulation obtained by the present invention was plotted against the total amount of carbonnanotube (mass %) to the total mass of the paste formulation. As shown in FIG. 6, the amount of carbonnanotube is added even in 1 mass %, the volume resistivity of the paste formulation becomes low enough to use in the present invention and it is estimated that the addition of about 10 mass % of the carbonnanotube provides excellent low resistivity to be about 10 kΩcm.

In addition, the paste formulations prepared in Examples 7-9, were preserved in a cylinder for paste injection, and the inventor examined that the paste formulation was discharged from the top. Subsequently, the paste formulation was injected into the root canal so as to conduct the root canal restoration operation.

The top of the electrode 104 of the resistance measuring device 100 shown in FIG. 5 was placed at the position slightly inside of the apical stricture P and the root canal restoration dental material was injected to the root canal. Then, the root canal restoration operation was possible while detecting completion of the filling of the paste formulation to the apical stricture.

### Comparable Example

Using the same components with the paste of Example 7, approximately 0.5 mass % of carbonnanotube, grade (A+B) type form Microphase Co. (Japan, Tsukuba-shi) was mixed to prepare the paste formulation according to the present invention. The volume resistivity of the prepared paste formulation exceeded 10⁶ Ωcm and sufficient volume resistivity was not obtained.

TABLE 1

| Grades | A + B type | C + D type |
|---|---|---|
| Average size | 3˜10 nm | 10˜30 nm |
| Purity | ≧80% | ≧90% |
| Layer | 1˜several | More than |
| numbers | layers | 5 layers |

TABLE 2

| | | Volume resistivity | |
|---|---|---|---|
| | Grades | (Ω cm) | Mass paecentage to paste formulations |
| Example 7 | A + B Type | 200 k Ω cm | 1.8 mass % |
| Example 8 | A + B Type | ≈200 Ω cm | 25 mass % |
| Example 9 | C + D Type | ≈200 Ω cm | 25 mass % |
| Comparable | A + B Type | >10⁶ Ω cm | 0.5 mass % |
| example | | | |

The present disclosure relates to subject matter contained in Japanese Application No. 2004-182538, filed on Jun. 21, 2004, the contents of which are expressly incorporated herein by reference in its entirely.

1. A root canal restoration dental material including carbonnanotube.

2. A root canal restoration dental material including a thermo-plastic polymer and an electric conductive material comprising carbonnanotube.

3. The root canal restoration dental material of claim 1, wherein said carbonnanotube is present therein from approximately 0.5 to approximately 25 mass %.

4. The root canal restoration dental material of claim 2, wherein said carbonnanotube is present therein from approximately 0.5 to approximately 25 mass %.

5. A root canal restoration dental material of claim 2, wherein a surface of a body of said material is coated with an electric conductive material comprising carbonnanotube.

6. The root canal restoration dental material of claim 2, wherein said thermo-plastic polymer is selected from the group consisted of gutta-percha, polyethylene, polypropylene, polyethylene glycol, polypropylene glycol and any admixture thereof.

7. The root canal restoration dental material of claim 3, wherein said thermo-plastic polymer is selected from the group consisted of gutta-percha, polyethylene, polypropylene, polyethylene glycol, polypropylene glycol and any admixture thereof.

8. The root canal restoration dental material of claim 4, wherein said thermo-plastic polymer is selected from the group consisted of gutta-percha, polyethylene, polypropylene, polyethylene glycol, polypropylene glycol and any admixture thereof.

9. The root canal restoration dental material of claim 5, wherein said thermo-plastic polymer is selected from the group consisted of gutta-percha, polyethylene, polypropylene, polyethylene glycol, polypropylene glycol and any admixture thereof.

10. The root canal restoration dental material of claim 1, wherein said material further includes at least one compound selected from the group consisted of zinc oxide, calcium hydroxide, hydroxyl apatite, tricalcium phosphate, potassium sulfate, aluminum sulfate, iodoform, barium sulfate, zinc sulfate anhydrate, bismuth bicarbonate and any admixture thereof.

11. The root canal restoration dental material of claim 2, wherein said material further includes at least one compound selected from the group consisted of zinc oxide, calcium hydroxide, hydroxyl apatite, tricalcium phosphate, potassium sulfate, aluminum sulfate, iodoform, barium sulfate, zinc sulfate anhydrate, bismuth bicarbonate and any admixture thereof.

12. The root canal restoration dental material of claim 3, wherein said material further includes at least one compound selected from the group consisted of zinc oxide, calcium hydroxide, hydroxyl apatite, tricalcium phosphate, potassium sulfate, aluminum sulfate, iodoform, barium sulfate, zinc sulfate anhydrate, bismuth bicarbonate and any admixture thereof.

13. The root canal restoration dental material of claim 4, wherein said material further includes at least one compound selected from the group consisted of zinc oxide, calcium hydroxide, hydroxyl apatite, tricalcium phosphate, potassium sulfate, aluminum sulfate, iodoform, barium sulfate, zinc sulfate anhydrate, bismuth bicarbonate and any admixture thereof.

14. The root canal restoration dental material of claim 5, wherein said material further includes at least one compound selected from the group consisted of zinc oxide, calcium hydroxide, hydroxyl apatite, tricalcium phosphate, potassium sulfate, aluminum sulfate, iodoform, barium sulfate, zinc sulfate anhydrate, bismuth bicarbonate and any admixture thereof.

15. The root canal restoration dental material of claim 6, wherein said material further includes at least one compound selected from the group consisted of zinc oxide, calcium hydroxide, hydroxyl apatite, tricalcium phosphate, potassium sulfate, aluminum sulfate, iodoform, barium sulfate, zinc sulfate anhydrate, bismuth bicarbonate and any admixture thereof.

16. The root canal restoration dental material of claim 1, wherein said composition is shaped to a root canal restoration point.

17. A paste formulation for dental use, wherein said paste formulation includes components for root canal restoration and an electric conductive material including carbonnanotube.

18. The paste formulation for dental use of claim 17, wherein said carbonnanotube is present from approximately 0.5 to approximately 25 mass % in said paste formulation.

19. The paste formulation for dental use of claim 17, wherein an X-ray imaging agent is present in said formulation.

20. The paste formulation for dental use of claim 17, wherein said paste formulation includes at least one compound selected from the group consisted of zinc oxide, calcium hydroxide, hydroxyl apatite, tricalcium phosphate, potassium sulfate, aluminum sulfate, iodoform, barium sulfate, zinc sulfate anhydrate, bismuth bicarbonate and any admixture thereof.
